(19) United States
(12) Patent Application Publication
(10) Pub. No.: US 2022/0358954 A1
(43) Pub. Date: Nov. 10, 2022

(54) Activity Recognition Using Inaudible Frequencies For Privacy

(71) Applicant: THE REGENTS OF THE UNIVERSITY OF MICHIGAN, Ann Arbor, MI (US)

(72) Inventors: Yasha IRAVANTCHI, Ann Arbor, MI (US); Alanson SAMPLE, Ann Arbor, MI (US)

(73) Assignee: THE REGENTS OF THE UNIVERSITY OF MICHIGAN, Ann Arbor, MI (US)

(21) Appl. No.: 17/735,268

(22) Filed: May 3, 2022

Related U.S. Application Data
(60) Provisional application No. 63/183,847, filed on May 4, 2021.

(51) Int. Cl. G10L 25/78; G10L 25/27; G06N 20/10

(52) U.S. Cl. CPC G10L 25/78; G10L 25/27; G06N 20/10

(57) ABSTRACT

Sound presents an invaluable signal source that enables computing systems to perform daily activity recognition. However, microphones are optimized for human speech and hearing ranges: capturing private content, such as speech, while omitting useful, inaudible information that can aid in acoustic recognition tasks. This disclosure presents an activity recognition system that recognizes activities using sounds with frequencies inaudible to humans for preserving privacy. Real-world activity recognition performance of the system is comparable to simulated results, with over 95% classification accuracy across all environments, suggesting immediate viability in performing privacy-preserving daily activity recognition.

### CROSS-REFERENCE TO RELATED APPLICATIONS

This application claims the benefit of U.S. Provisional Application No. 63/183,847, filed on May 4, 2021. The entire disclosure of the above application is incorporated herein by reference.

### FIELD

The present disclosure relates to activity recognition using sounds in inaudible frequencies for preserving privacy.

### BACKGROUND

Microphones are perhaps the most ubiquitous sensor in computing devices today. Beyond facilitating audio capture and replay for applications such as phone calls and connecting people, these sensors allow computers to perform tasks as our digital assistants. With the rise of voice agents, embodied in smartphones, smartwatches, and smart speakers, computing devices use these sensors to transform themselves into listening devices and interact with us naturally through language. Their ubiquity has led them to find other purposes beyond speech, powering novel interaction methods such as in-air and on-body gestural inputs. More importantly, microphones have found use within health sensing applications, such as measuring lung function and performing cough detection. While the potential of ubiquitous loT devices is limitless, the ever-present, ever listening microphone presents significant privacy concerns to users.

This conflict leaves us at a crossroads: How do we capture sounds to power these helpful, always-on applications without capturing intimate, sensitive conversations? The current “all-or-nothing” model of disabling microphones in return for privacy throws away all the microphone-based applications of the past three decades.

Typically, the microphones that drive our modern interfaces are primarily designed to operate within human hearing—roughly 20 Hz to 20 kHz. This focus on the audible spectrum is perhaps not surprising given these microphones are most often used to capture sounds for transmission or playback to other people. However, removing the speech portion of the audible range reduces the accuracy of audible-only sound classification systems, as speech makes up almost half of the audible range. Fortunately, there exists a wealth of information beyond human hearing: in both infrasound and ultrasound. The human-audible biases in sound capture needlessly limit computers' ability to utilize sound. However, useful, inaudible acoustic frequencies can be used to generate new sound models and perform activity recognition, entirely without the use of human-audible sound. Furthermore, these inaudible frequencies can replace privacy-sensitive frequency bands, such as speech, and compensate for the loss of information when speech frequencies are removed.

This disclosure explores sounds outside of human hearing and their utility for sound-driven event and activity recognition.

This section provides background information related to the present disclosure which is not necessarily prior art.

### SUMMARY

This section provides a general summary of the disclosure, and is not a comprehensive disclosure of its full scope or all of its features.

An activity recognition system is presented. The system is comprised of: a microphone; a filter; an analog-to-digital converter (ADC); and a signal processor. The microphone is configured to capture sounds proximate thereto. The filter is configured to receive an audio signal from the microphone and operates to filter sounds with frequencies audible to humans from the audio signal. An analog-to-digital converter (ADC) is configured to receive the filtered audio signal and output a digital signal corresponding to the filtered audio signal. The signal processor analyzes the digital signal from the ADC and identifies an occurrence of an activity captured in the digital signal using machine learning.

In one embodiment, the filter operates to filter sounds with frequencies in range of 20 Hertz to 20 kilohertz. In another embodiment, the filter operates to filter sounds with frequencies in range of 300 Hertz to 16 kilohertz. In yet another embodiment, the filter operates to filter sounds with frequencies less than 8 kilohertz.

A method for recognizing activities is also presented. The method includes: capturing sounds with a microphone; generating an audio signal representing the captured sounds in time domain; filtering sounds with frequencies in a given range from the audio signal, where the frequencies in the given range are those spoken by humans; computing a representation of the audio signal in a frequency domain by applying a fast Fourier transform; and identifying an occurrence of an activity captured in the audio signal using machine learning.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a bar plot showing predictive power for each frequency in a range of frequencies.

FIG. 1B is a bar plot showing twenty most important frequencies ranked in order.

FIG. 2 is a diagram depicting an activity recognition system.

FIG. 3 is a schematic of the example embodiment of the activity recognition system.

FIGS. 4A and 4B are Bode plots generated from linear sweeps of the speech and audible filters, respectively.

FIG. 5 is a graph showing distance response curves across four test frequencies.

FIGS. 6A and 6B are confusion matrices for real world evaluations with speech filtered out and audible filtered out, respectively.

Corresponding reference numerals indicate corresponding parts throughout the several views of the drawings.

### DETAILED DESCRIPTION

Given the number of animals that can hear sub-Hz infrasound (e.g., whales, elephants, and rhinos) and well into ultrasound (e.g., dogs to 44 kHz, cats to 77 kHz, dolphins to 150 kHz), it is perhaps unsurprising that there is a world of exciting sounds around us that we cannot hear. While these animals have adapted their hearing for long-distance communication, hunting prey, and echolocation, similar to microphones, human hearing has evolved for human sounds and speech. This disclosure presents an information power study to explore the inaudible world and answer two fundamental questions: (1) Do daily-use objects emit significant infrasonic and ultrasonic sounds? (2) If the devices do emit these sounds, are these inaudible frequencies useful for recognition?

To collect sounds from three distinct regions of the acoustic spectrum, an audio-capture rig was built that combines three microphones with targeted frequency responses: infrasound, audible, and ultrasound. While these microphones have overlap in frequency responses, acoustic frequency ranges and source signals from the appropriate microphone are defined with the least attenuation to create a “hybrid” microphone. The microphones are all connected via USB to a standard configuration 2013 MacBook Pro 15″ for synchronized data capture. The internal microphone in the MacBook Pro was also captured as an additional audible source for possible future uses. A webcam was added to provide video recordings of the objects in operation. FFMpeg (Fast Forward Moving Pictures Expert Group) was used to simultaneously capture from all audio sources and the webcam, synchronously. FFMpeg was configured to use a lossless WAV codec for each of the audio sources (set to the appropriate sampling rate) and H.264 with a QScale of 1 (Highest Quality) for the video recording. These choices were to ensure that no losses due to compression occurred in the data collection stage.

Infrasound is defined as frequencies below human hearing (i.e., f<20 Hz). To capture infrasonic acoustic energy, an Infiltec INFRA20 Infrasound Monitor is used, via a Serial-to-USB connector. The INFRA20 has a 50 Hz sampling rate with a pass-band from 0.05 Hz to 20 Hz. While the sensor itself has a frequency response above 20 Hz, the device has an analog 8 Pole elliptic filter with a 20 Hz corner frequency low pass filter. As a result, the INFRA20 is not used to source acoustic signal for any other acoustic region. While humans can detect sounds in a frequency range from 20 Hz to 20 kHz, this is often in ideal situations and childhood, whereas the upper limit in average adults is often closer to 15-17 kHz. For this study, the upper limit of audible is defined as the midpoint of that range, resulting in a total audible range of 20 Hz<f<16 kHz. To capture audible signals, a Blue Yeti Microphone set to Cardioid mode to direct sensitivity towards the forward direction with a gain of 50%. The Yeti has a 48 kHz sampling rate and a measured frequency response of 20 Hz to 20 kHz. While the ultrasonic microphone's frequency response includes the Yeti's entirely, the Yeti had less attenuation from 10 kHz to 16 kHz. As a result, the audible signal is source solely from the Yeti.

For ultrasound frequencies (f>16 kHz), a Dodotronic Ultramic384 k is used. The Ultramic 384 k has a 384 kHz sampling rate, with a stated frequency range up to 192 kHz. The Ultramic384 k uses a Knowles FG-series Electret capsule microphone. In laboratory testing, the Ultramic384 k continues to be responsive above 110 kHz up to the Nyquist limit of 192 kHz and as low as 20 Hz. The Ultramic384 k had less attenuation than the Yeti from 16 kHz to 20 kHz (the upper limit of the Yeti), resulting in an ultrasound signal sourced solely from the Ultramic384 k.

To introduce real-world variety and many different objects, including different models of the same item (e.g., Shark vacuum vs. Dyson vacuum), data was collected across three homes and four commercial buildings. More information about these locations and a full list of all these objects can be seen in Table 1 below. In the real world, sensing devices are not always afforded the luxury of perfectly direct and close sensing. A 45° angle at a distance of 3 m are reasonable parameters (less than −12 dB attenuation) to simulate conditions experienced by a sensing device in the home or office while still retaining good signal quality. For some of items, physical constraints (e.g., small spaces like kitchens and bath-rooms) prevented us from measuring at those angles and distances. In those cases, a best effort was made to maintain distances and angles that would be expected in a real-world sensor deployment.

Before recording the object, a 5-second snapshot was taken as a background recording to be used later for background subtraction. Almost immediately after, the item was activated, and a 30-second recording was performed. Five instances of background recording and item recording were captured for each item. For items that do not require human input to continue operation, such as a faucet, the item was turned on prior to the beginning of the 30-second recording, but after the 5-second snapshot, and left on for the entirety of the clip. For an item that required human input, such as flushing a toilet, the item was repeatedly activated for the entire duration of the clip (i.e., every toilet clip has multiple flushes). The laptop's microphone and video from the webcam on the rig were also captured in the clips for potential future use. If multiple items were being recorded in the same session, the items were rotated through in a random order rather than capturing five instances of each item sequentially to avoid similarity. If only one item was being captured in that session, the rig would be moved and replaced prior to recording. This was to prevent the capture from being identical and adds variety for machine learning classification. Lastly, if objects had multiple “modes” (e.g., faucet normal vs. faucet spray), modes were captured as separate instances.

Sounds were collected in three homes: one apartment, one townhome, and one single-family single-story home. 71 of the 127 sounds were sourced in homes. In the kitchen, captured sounds were from kitchen appliances such as blenders and coffee makers as well as commonly found fixtures such as faucets and drawers. Overall, 30 different kitchen objects were collected across three homes. In the bathroom, captured sounds were from water-based sources such as toilets and showers. Additionally, captured sounds were from everyday grooming objects, such as electric toothbrushes, electric shavers, and hairdryers. Overall, 24 different bathroom objects were collected across three homes. Apart from those two contexts, captured sounds included general home items, such as laundry washers and dryers, vacuum cleaners, and shredders. Sounds were also captured from two vehicles, one motorcycle and one car. This resulted in an additional 17 objects collected across two of the three homes.

Sounds were also collected in commercial buildings, as the general nature of similar objects differs and introduces a variety of different objects. Four different environments were chosen across four commercial buildings: workshops, office spaces, bathrooms, and kitchenettes. Sounds were collected from objects of interest that did not fit in those four categories. 56 of the 127 sounds were sourced in commercial buildings. The workshop contained primarily power tools such as saws and drills, as well as specialized tools, such as laser cutters and CNC machines. Sounds were also captured from fixtures such as faucets and paper towel dispensers. Overall, 12 objects were sourced from one of the four commercial buildings. The commercial bathroom, similar to the home bathroom, focused on water-based sounds from toilets and faucets but also contained sounds from things not commonly found in home bathrooms like paper towel dispensers and stall doors. This environment contributed 16 objects from three of the four commercial buildings.

The kitchenette consisted of small office/workplace-style kitchens containing microwaves, coffee machines, and sometimes dishwashers and faucets. This environment contributed to 18 objects from two of the four commercial buildings. The office space contained sounds such as doors, elevators, printers, and projectors, contributing 6 distinct sounds from one of the four commercial buildings. The miscellaneous category contained sounds that were collected in the commercial buildings but did not fit in the above four categories. This included items such as vacuums and a speaker amplifier, contributing 4 items from one of the four commercial buildings.

To evaluate the importance of each region of acoustic energy, first raw signals were featurized using a log-binned Fast Fourier Transform (FFT), which was then analyze using information power metrics. Finally, these metrics were used to perform classification tasks using different combinations of features sourced from distinct acoustic regions.

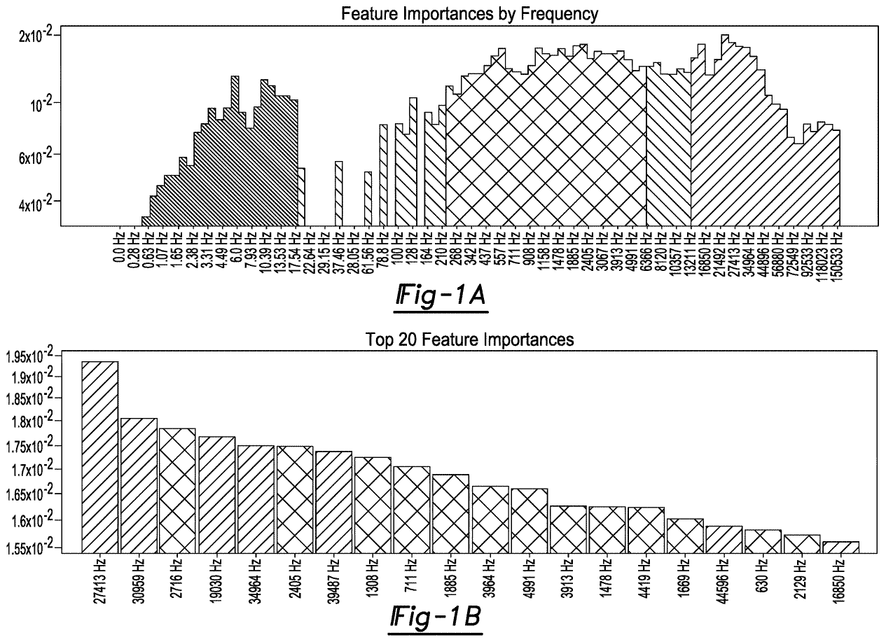

In order to provide features for feature ranking and machine learning, a high-resolution FFT was created for the infrasound, audible, and ultrasound recordings, for both the background and the object. Then background subtraction was performed, subtracting the background FFT components from the object's FFT. This allows one to create a very clean FFT signature of solely the object, which minimizes the machine learning models from learning the background rather than the object itself. While practical in some situations, using fixed bin sizes with 0.1 Hz resolution results in a feature vector containing approximately 2 million features. Therefore, to maintain high frequency resolution at low frequencies while keeping the number of features reasonable, a 100 log-binned feature vector is used from 0 Hz to 192 kHz. This resulted in 27 infrasound bins, 53 audible bins, and 20 ultrasound bins. These feature vectors (and subsets of these vectors) will be used as inputs both for feature ranking tasks and classification tasks. The feature bins can be seen in FIG. 1A.

While it is prevalent for sound-based methods to use Mel-frequency cepstral coefficients (MFCCs), this study opted for FFTs due to their versatility in capturing the signal outside of human-centric speech. MFCCs are widely used for speech recognition and employ the Mel filter bank to optimize human hearing and auditory perception. As humans are better at discerning pitch changes at low frequencies rather than higher ones, the Mel filter bank becomes broader and less concerned with variations for higher frequencies. Therefore, while great for detecting human speech, which has a fundamental frequency from 300 Hz and a maximum frequency of 8 kHz, it allocates a large portion of the coefficients in that low fundamental frequency range and performs poorly in capturing the discriminative features at higher frequency ranges as its resolution decreases.

To quantify the importance of each spectral band, feature selection methods were employed that rank each band by its information power. There are several ways this can be done, including unsupervised feature selection or dimensionality reduction methods, such as Principal Component Analysis (PCA). However, given a well-labeled dataset, one can perform supervised feature selection and classification using Random Forests, which are robust and can build a model using the Gini impurity-based metric. Using the Gini impurity to measure the quality of split criterion, one can quantify the decrease in the weighted impurity of the feature in the tree, which indicates its importance. Another critical aspect of Random Forests is that it decreases the importance of features already duplicated by other features: given a spectral band that has high importance and another spectral band that represents a subset of the same information, the importance of the latter will be reduced. As the goal is not to study the relationship between features but to quantify the singular importance of each band, this metric allows one to quantify the standalone information power of each band.

FIG. 1B shows the top 20 features sorted by importance from most important to least important. Of the top 20 features, all audible features are within the privacy-sensitive speech range. FIG. 1A shows the feature importance sorted by frequency. Further examination shows that for infrasound, features below 1 Hz have zero information power. This is because this study did not capture a significant number of objects that emit sub-Hz acoustic energy and only two of the objects (HVAC Furnace and Fireplace) had the majority of their spectral power in infrasound. Below 210 Hz there is a gradual tapering of feature importance for audible frequencies, which is likely due to a similar reason. For ultrasound, the greatest components came in the low ultrasound region (f<50 kHz), which also contained 5 of the top 10 components. The average importance for infrasound, audible, and ultrasound was 0.006, 0.011, and 0.013. Infrasound (27 bins), audible (53 bins), and ultrasound (20 bins) contributed 16.2%, 57.8%, and 26% of the total information power, respectively.

Results of spectral analysis are quantified in terms of classification accuracies as well. For this evaluation, a Random Forest Classifier is used with 1000 estimations and evaluate performance in a leave one round out cross-validation setting. Given that there are five instances of each class type, the training set is divided into four instances of each class, and the corresponding test set contains one instance of each class, across five rounds. Other techniques, such as Support Vector Machines and Multi-Layer Perceptron, achieved similar performances.

The usefulness of each frequency band is quantified in terms of its impact on activity recognition. When using only infrasound frequency bins, the system achieves a mean classification accuracy of 35.0%. For human audible, the system achieves an accuracy of 89.9%. Using only ultrasound, the system achieves an accuracy of 70.2%. When using the full spectrum of acoustic information, a mean classification accuracy of 95.6% is achieved.

It is interesting to note that compact fluorescent lightbulbs (CFLs) and humidifiers have powerful ultrasonic components, with minimal audible components, and are only distinguishable in that band. The fireplace has more significant components in infrasound than in ultrasound and audible, and the HVAC furnace solely emits infrasound. The mutual information from all bands also helps to build a more robust model for fine-grained classification. Particularly interesting are items that sound similar to humans, such as water fountains and faucets, which are confused in audible ranges, but can be distinguished when using ultrasonic bands. Also, items such as projector and toaster oven, which were misclassified by each band individually, were only correctly predicted when combining all frequency bands' information.

To preserve privacy, performance of the system was evaluated without the use of frequencies audible to humans. Specifically, three scenarios were evaluated: all audible frequency ranges bereft of speech, audible and ultrasound bereft of speech, and full-spectrum bereft of FFT based speech features (from 300 Hz to 8000 Hz to include higher-order harmonics). A significant drop in performance occurred when removing speech frequencies from audible, from 89.9% to 50.5%. The system retained robustness when using privacy-preserving audible+ultrasound and full-spectrum, suffering an accuracy drop of only 5.3% and 4.2%, respectively.

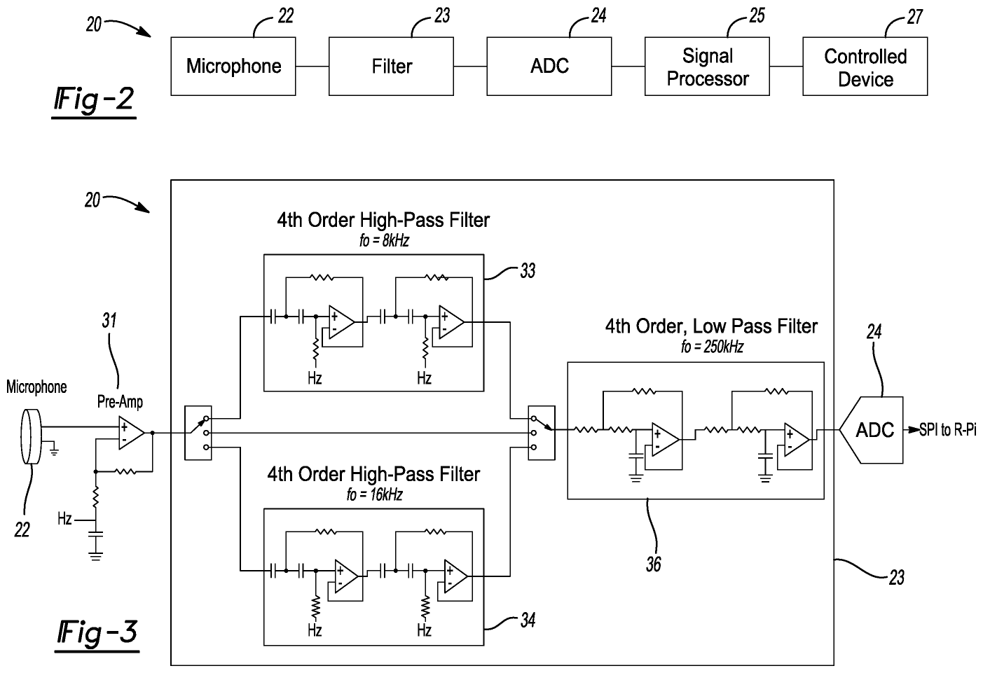

From the findings of this information power study, an activity recognition system 20 is proposed as seen in FIG. 2. The activity recognition system 20 is comprised generally of a microphone 22, a filter 23, an analog-to-digital converter (ADC) 24 and a signal processor 25. The activity recognition system may be interfaced with one or more controlled devices 27. Controlled devices may include but are not limited to household items (such as lights, kitchen appliances, and cleaning devices), commercial building items (such as doors, printers, saws and drills), and other devices.

A microphone 22 is configured to capture sounds in a room or otherwise proximate thereto. In order to faithfully capture high-audible and ultrasonic frequencies, a microphone is selected that has sufficient range (e.g., 8 kHz-192 kHz) and could be filtered in-hardware. In-hardware filtering removes privacy sensitive frequencies, such as speech, in an immutable way, preventing an attacker from gaining access to sensitive content remotely or by changing software. In-hardware filtering also ensures that no speech content will ever leave the device when set to speech or audible filtered, since the filtering is performed prior to the ADC.

In some embodiments, the filtering may be integrated into the microphone 22. That is, the microphone may be design to capture sounds in a particular frequency range. While there are a number of Pulse Density Modulation (PDM) microphones that would fulfill the frequency range requirements, performing in-hardware filtering is significantly easier in the analog domain. Thus, in the example embodiment, the Knowles FG microphone is used in the system 20. Since the Knowles FG microphone produces small signals (25 ₘVₚₚ), the audio signal are preferably amplified with an adjustable gain (default G =10) prior to filtering. Other types of microphones are also contemplated by this disclosure.

A filter 23 is configured to receive the audio signal from the microphone 22. In one example, the filter 23 filters sounds with frequencies audible to humans (e.g., 20 Hertz to 20 kilohertz) from the audio signal. In another example, the filter 23 filters sounds with frequencies spoken by humans (e.g., 300 Hertz to 8 kilohertz or 300 Hertz to 8 kilohertz) from the audio signal. In yet another example, the filter 23 filters sounds below ultrasound (e.g., less than 8 kilohertz) from the audio signal. These frequency ranges are intended to be nonlimiting and other frequency ranges are contemplated by this disclosure. It is readily understood that high pass filters, low pass filters or combinations thereof can be used to implement the filter.

FIG. 3 is a schematic of the example embodiment of the activity recognition system 20. In this embodiment, an amplifier circuit 31 is interposed between the microphone 22 and the filter 23. In addition, the filter 23 is comprised of two high-pass filters 33, 34 arranged in parallel and a low pass filter 36. To select a circuit path, the amplifier circuit 31 is connected to a double pole triple throw switch 32, connecting the amplified signal to a high pass speech filter 33 (f_{c}=8 kHz), an audible filter 34 (f_{c}=16 kHz), or directly passed through unfiltered. The audio signals are then passed on to the low-pass filter 36. The low pass filter 36 is preferably set to the Nyquist limit of the ADC (f_{c}=250 kHz) to remove aliasing, high frequency noise, and interference. Other filter arrangements are contemplated by this disclosure.

An analog-to-digital converter (ADC) 24 is configured to receive the filtered audio signal and output a digital signal corresponding to the filtered audio signal. For example, a high-speed low-power SAR ADC samples the audio signals (e.g., up to 500 kHz).

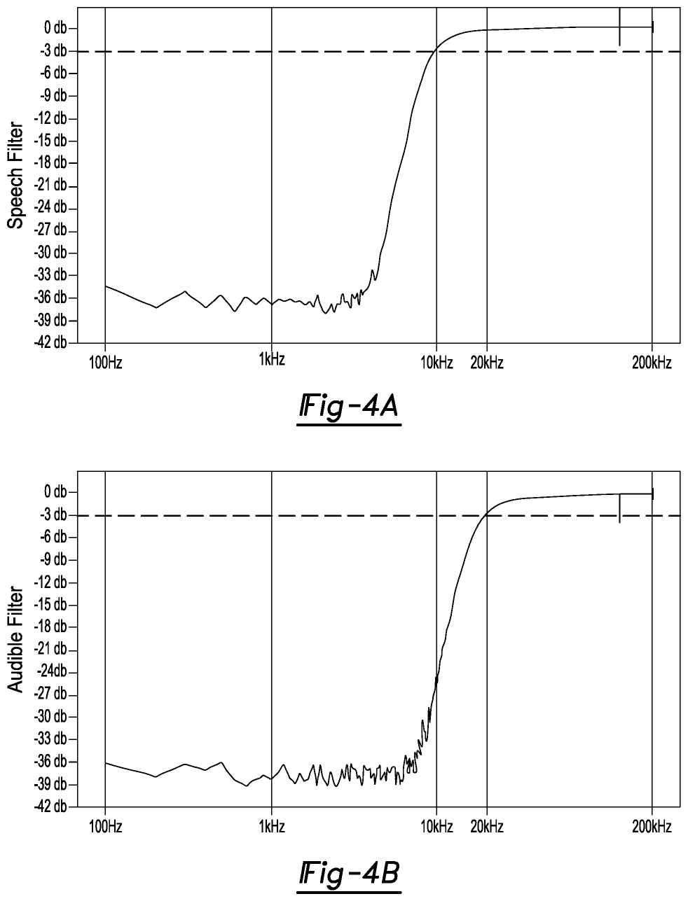

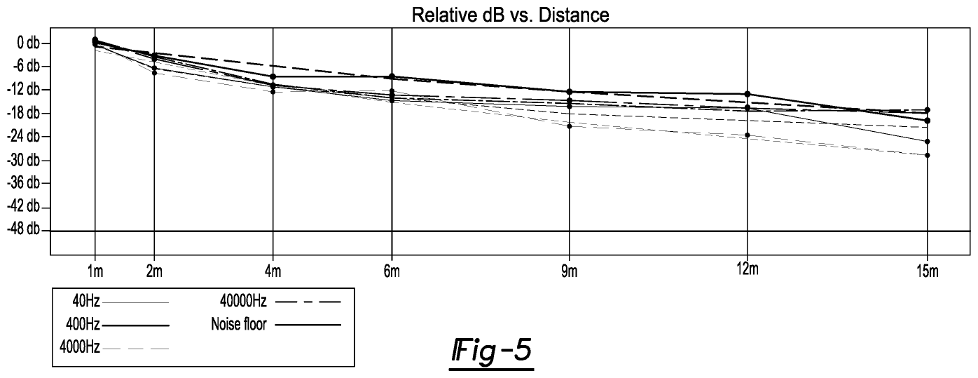

As proof of concept, filter performance was evaluated. Instead of performing frequency sweeps using a speaker and microphone, which introduces inconsistencies through the frequency response of the microphone and output speaker, the microphone was bypassed and input was provided directly to the filters using a function generator. A continuous sine input of 200 mVpp at 8 kHz and 16 kHz was provided to the speech and audible filters, respectively, and for both filters, the resultant signal through the filter was at or less than −6 dB (i.e., less than 50% amplitude). For both filters, a linear sweep and a log sweep were performed from 100 Hz to 100 kHz and significant signal suppression occurred below the filter cutoff. FIGS. 4A and 4B show the filter performance of the speech filter and the audible filter, respectively.

To evaluate how well the microphone is able to pick up sounds from a distance, an audible speaker and a piezo transducer were driven at different frequencies using a function generator with the output set to high impedance and amplitude to 10 Vpp. While the impedances of the speakers were not equal, comparisons are not made across or between speakers. In order to minimize the effects of constructive and destructive interference due to reflections, a large, empty room (18 m long, 8.5 m wide, 3.5 m tall) was used to perform acoustic propagation experiments. Distances of 1 m, 2 m, 4 m, 6 m, 9 m, 12 m, and 15 m at an angle of 0° (direct facing) were marked, placing the microphone at each distance resulting in 7 measurements per frequency. For each measurement, the RMS is calculated for the given test frequency (i.e., the signal was filtered and all other frequency components/noise removed). The values of each angle are normalized to the max RMS value for that frequency. Fit an exponential curve in the form y=a*e−b*x+c is fit to the data. FIG. 5 shows that across multiple frequencies, the microphone is able to pick up signals well above the noise floor (even 15 m away). It is important to note that while the system does not use any frequencies below 8 kHz, they were included for comparative purposes.

Returning to FIG. 2, a signal processor 25 is interfaced with the ADC 24. During operation, the signal processor 25 analyzes the digital signal and identifies an occurrence of an activity captured in the digital signal using machine learning. More specifically, the signal processor 25 first computes a representation of the digital signal in a frequency domain. In one example, the signal processor 25 applies a fast Fourier transform to the digital signals received from the ADC 24 in order to create a representation of the digital signals in frequency domain. Although fix bin sizes could be used, the features output by the FFT are preferably grouped using logarithmic binning. Other possible binning methods include Log(base2), linear, exponential and power series. It is also envisioned that other type of transforms may be used to generated a representation of the digital signals in the frequency domain.

Next, an occurrence of an activity captured in the digital signal is identified by classifying the extracted features using machine learning. In one example embodiment, the features are classified using random forests. In some embodiments, feature selection techniques are used to extract the more important features before classification. For example, supervised feature selection methods, such as decision trees, may be used to extract important features which in turn are input into support vector machines. In yet other embodiments, the raw digital signals from the ADC 24 may be input directly into a classifier, such as a convolutional neural network. These examples are merely intended to be illustrative. Other types of classifiers and arrangements for classification fall within the scope of this disclosure. The signal processor 25 may be implemented by a Raspberry Pi Zero which in turn sends each data sample to a computer via TCP.

The signal processor 25 may be interfaced or in data communication with one or more controlled devices 27. Based on the identified activity, the signal processor 25 can control one or more of the controlled devices. For example, the signal processor 25 may turn on or turn off a light in a room. In another example, the signal processor 25 may disable dangerous equipment, such as a stove or band saw. Additionally or alternatively, the signal processor 25 may record occurrence of identified activities in a log of a data store, for example for health monitoring purposes. These examples are merely illustrative of the types of actions which may be taken by the activity recognition system.

There are numerous privacy concerns surrounding always-on microphones in our homes placed in locations where they have access to private conversation. Two possible avenues where microphones can be compromised are bad actors gain access to audio streams off the device directly or through mishandled data breaches. A user study evaluates whether the participants were able to perceive various levels of content within a series of audio clips, as if they were an eavesdropper listening to a audio stream. This evaluation is used to confirm previously selected frequency cutoffs of 8 kHz for speech and 16 kHz for audible.

Three audio files were generated by reading a selected passage from Wikipedia for approximately 30 seconds. For file A, a speech filter was used to remove all frequencies below 8 kHz. While speech frequencies were removed, some higher frequency fragments of speech remained in the speech filtered file. To simulate a potential attack vector, the harmonic frequencies were pitched shifted down to 300 Hz (the lower range of human voice frequencies), and generated file B. For file C, an audible filter was used; removing all frequencies below 16 kHz. All of the files were saved as a 16-bit lossless WAV. Eight participants (Table 2) were asked to respond on a Likert scale (1 to 7, 1 being “Not at all” and 7 being “Very clearly”) to the questions seen in Table 2.

General comments per file and comments comparing the three files were also elicited from the participants. The participants were asked to wear headphones for this study; they were permitted to increase or decrease volume to their preference and listen to the clip multiple times.

File A, which had all speech frequencies removed, had mixed responses on whether the participants could hear something in the file. However, participants were in general agreement that they could not hear human sounds and were almost unanimous that they could not hear speech. The ones that said they could hear speech stated “someone speaking but not inaudible” and “it sounds like grasshoppers but the cadence of the sounds seems like human speech”. All participants agreed with a score of 1 that they could not hear speech well enough to transcribe. None were able to transcribe a single word from the audio clip.

For file B, which was the pitch shifted version of file A, more participants stated that they could hear something in the file, and a greater number stated that they were human sounds, but again the majority could not identify the sound as speech: “it sounded like someone was breathing heavily into the mic” and “it sounds like a creepy monster cicada chirping and breathing”. All but one participant stated with a score of 1 that they could not hear speech well enough to transcribe. None were able to transcribe a single word from the audio clip.

File C, which had all audible frequencies removed, had fewer participants than file A or file B report that they could hear things in the file. Additionally, all but one reported with a score of 1 that they could attribute the sounds to human, and all but one reported with a score of 1 that they were able to hear speech. The same participant who recognized the cadence in file A also reported “Sounds like tinny, squished mosquito. Could make out the cadence of human speech”. None were able to transcribe a single word from the audio clip.

Additionally, the audio files were processed through various natural language processing services (CMU Sphinx, Google Speech Recognition, Google Cloud Speech to Text) and it was found that none of them were able to detect speech content within the files. All of these services were able to transcribe the original, unfiltered audio correctly.

While the simulated performance offers promising results, the system performance was also evaluated in a less controlled environment. Rather than consistently placing the microphone 3 m and 45° from the object, the microphone is placed in a natural location relative to its environment in this real-world evaluation, which introduces variety and realism. Background subtraction is not performed and the objects remain in their natural setting, allowing for a mixture of volumes and distances.

The system was place near an electrical outlet for each environment, similar to typical loT sensor placement such as an Alexa. Ten rounds were collected for each object in that environment, capturing ten instances per round, 3000 samples per instance. Since this evaluation did not evaluate across environments (and real-world systems do not have the luxury of background subtraction), a background clip was not collected for background subtraction. Additionally, for each environment, ten rounds of the “nothing” class were also collected, where none of the selected objects were on. This procedure was repeated for both the speech filter and the audible filter.

A real-world evaluation is performed in three familiar environments similar to the previous evaluation: kitchen, bathroom, and office. For the kitchen environment, the kitchen sink, the microwave, and a handheld mixer were used. For the office environment, sounds included writing with a pencil, using a paper shredder, and turning on a monitor. For the bathroom environment, an electric toothbrush, flushing a toilet, and the bathroom sink were used.

After collecting the data, a leave-one-round-out evaluation was performed, trained on nine rounds and tested on the tenth, and all combination results averaged.

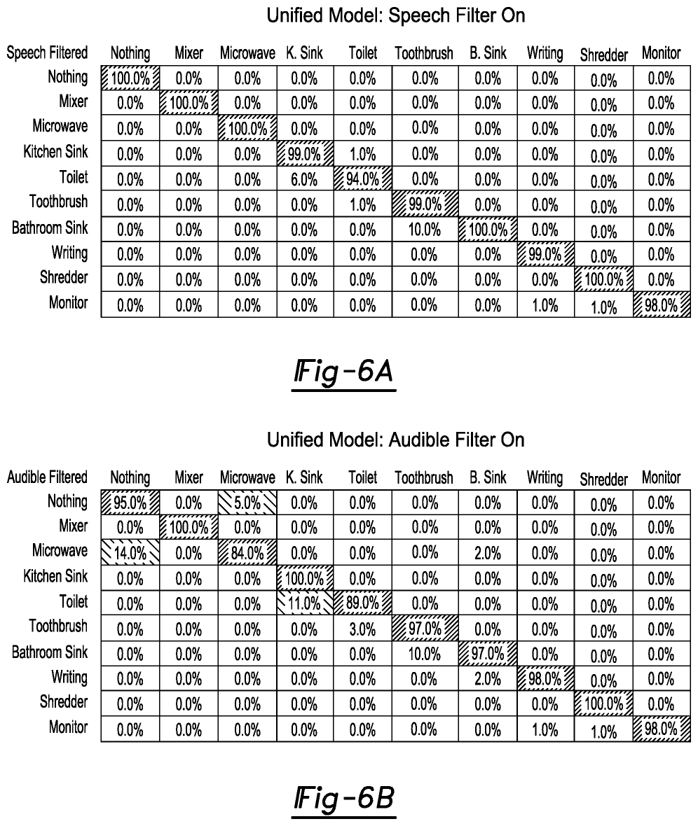

Performance results were consistent with earlier results using the speech filter, where frequencies less than 16 kHz are removed. For the kitchen environment, one found an average accuracy of 99.3% (SD=1.1%). For the bathroom environment, one found an average accuracy of 99.7% (SD=0.8%). For the office environment, one found an average accuracy of 99.3% (SD=1.1%). The performance of a unified model was explored as well, where a leave-one-round-out evaluation was performed on all 10 classes. In order to prevent a class imbalance (as there are three times the number of instances for the nothing class), perform the nothing class from each environment separately and average the results. For the unified model, one finds an average accuracy of 98.9% (SD=0.7%). The confusion matrices for each condition can be found in FIG. 6A.

Performance results were consistent with the earlier results using the audible filter, but slightly degraded compared to the speech filter, where frequencies less than 16 kHz are removed. For the kitchen environment, one finds an average accuracy of 95.0% (SD=2.7%). For the bathroom environment, one finds an average accuracy of 98.2% (SD=2.2%). For the office environment, one finds an average accuracy of 99.3% (SD=1.6%). Similar to the speech filter results, the performance of a unified model is evaluated and resulted in an average accuracy of 95.8% (SD=2.1%). The confusion matrices for each condition can be found in FIG. 6B.

While classification accuracies suggest that the audible range is the most critical standalone acoustic range, the average importance of each bin was greater in ultrasound by 18% compared to audible, making it the most valuable region per bin. When restricting input frequencies to only “safe” frequency bands, classification accuracies suggest a different story: ultrasound alone provides an almost 20% improvement over privacy-preserving audible (where speech is removed). When privacy-preserving audible is combined with ultrasound, classification accuracies surpass traditional audible performances that includes speech frequencies. These two frequency combinations are precisely what the activity recognition system leverages as input when using its speech and audible filters

As the number of listening devices grows in our lives, the implications of privacy become of greater importance. All smart speech-based personal assistants require a key-phrase for invocation, like “Hey Siri” or “Ok Google.” In an ideal world, these devices do not “listen” until the phrase is said, but, this prohibits a platform from truly achieving real-time, always-running activity recognition. The converse is always listening devices, which are continuously processing sounds. There are serious privacy concerns around these devices, as improper handling of data can lead to situations where speech and sensitive audio data is recorded and preserved. While the eavesdropping evaluation is by no means an exhaustive study to prove that the proposed system definitively removes all traces of speech, it shows that at least in the case of someone “listening in” to audio data recorded via the activity recognition system that speech is no longer intelligible.

Using ultrasonic frequencies also has implications on device hardware. In FIGS. 1A and 1B, looking at the ultrasound bins, there's a drop-off in importance for frequency components above 56 kHz. Further, all of the ultrasonic bins that appear in the top 20 feature importance's exist outside of the range of most microphones (above 20 kHz), yet below 45 kHz. While components outside of those ranges are not unimportant, it suggests that future devices are not far away from capturing a few more high-importance frequency ranges before the cost outweighs the benefit. Simply put, if the upper limit of devices were extended from 20 kHz to 56 kHz, they would capture 86.4% of the total feature importance of the full spectrum analyzed in this study.

Further, using inaudible frequencies encompass sensing capabilities that were commonly associated with other sensors. For example, to determine whether the lights or a computer monitor is on, a photo sensor and RF module are reasonable choices of sensors. Utilizing ultrasound, the activity recognition system can “hear” light bulbs and monitors, two devices that are silent to humans.

Augmentation is an approach to generating synthetic data that includes variations to improve the robustness of machine learning classifiers. For traditional audible audio signals, these approaches include noise injection, pitch shifting, time shifts, and reverb. Another aspect of this disclosure is to augment ultrasonic audio data that includes, but is not limited to, noise injection, pitch shifting, time dilation, and reverb, for continuous periodic signals and impulse signals. Using augmented data, one can generate synthetic data that simulates ultrasonic signals at different distances and different environments, which improves real-world performance.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

APPENDIX

TABLE 1

| | Classification | Privacy |
|---|---|---|
| Input Frequencies | Accuracy | Preserving |
| Infrasound | 35.0% | Yes |
| Audible (Speech Removed) | 50.5% | Yes |
| Ultrasound | 70.2% | Yes |
| Full Spectrum (Audible Removed) | 80.2% | Yes |
| Audible | 89.9% | No |
| Audible + Ultrasound (Speech Removed) | 90.3% | Yes |
| Full Spectrum (Speech Removed) | 91.4% | Yes |
| Audible + Ultrasound | 92.8% | No |
| Audible + Infrasound | 93.2% | No |
| Full Spectrum | 95.6% | No |

Infrasound: f < 25 Hx, Speech: 300 Hz < f < 8 kHz, Audible: 20 Hz < f < 16 kHz, Ultrasound: f > 16 kHz

What is claimed is:

1. An activity recognition system, comprising:
a microphone configured to capture sounds proximate thereto;
a filter configured to receive an audio signal from the microphone and operates to filter sounds with frequencies audible to humans from the audio signal;
an analog-to-digital converter (ADC) configured to receive the filtered audio signal and output a digital signal corresponding to the filtered audio signal; and
a signal processor interfaced with the ADC, where the signal processor analyzes the digital signal and identifies an occurrence of an activity captured in the digital signal using machine learning.

2. The activity recognition system of claim 1 wherein the filter operates to filter sounds with frequencies in range of 20 Hertz to 20 kilohertz.

3. The activity recognition system of claim 1 wherein the filter operates to filter sounds with frequencies in range of 300 Hertz to 16 kilohertz.

4. The activity recognition system of claim 1 wherein the filter operates to filter sounds with frequencies less than 8 kilohertz.

5. The activity recognition system of claim 1 further comprises an amplifier circuit coupled to the microphone.

6. The activity recognition system of claim 1 wherein the signal processor computes a representation of the digital signal in a frequency domain.

7. The activity recognition system of claim 6 wherein the signal processor applies a fast Fourier transform to the digital signal and creates the representation of the digital signal in using logarithmic binning.

8. The activity recognition system of claim 1 wherein the signal processor identifies an occurrence of an activity captured in the digital signal using random forests.

9. The activity recognition system of claim 1 further comprises a device in data communication with the signal processor, where the signal processor enables or disables the device based on the identified activity.

10. A method for recognizing activities, comprising:
capturing sounds with a microphone;
generating an audio signal representing the captured sounds in time domain;
filtering sounds with frequencies in a given range from the audio signal, where the frequencies in the given range are those spoken by humans;
computing a representation of the audio signal in a frequency domain by applying a fast Fourier transform; and
identifying an occurrence of an activity captured in the audio signal using machine learning.

11. The method of claim 10 wherein the frequencies in the given range are between 300 Hertz and 8 kilohertz.

12. The method of claim 10 further comprises computing a representation of the audio signal by grouping output of the fast Fourier transform using logarithmic binning.

13. The method of claim 10 further comprises identifying an occurrence of an activity captured in the audio signal using random forests.

14. The method of claim 10 further comprises identifying an occurrence of an activity captured in the audio signal using a neural network.

15. The method of claim 10 identifying an occurrence of an activity captured in the audio signal further comprises extracting features from the representation of the audio signal using decision trees and inputting the extracted features into a support vector machine.

16. The method of claim 10 further comprises controlling a device based on the identified activity.

17. The method of claim 16 wherein controlling a device further comprises enabling or disabling the device.
